(19) United States
(12) Patent Application Publication
(10) Pub. No.: US 2020/0049950 A1
(43) Pub. Date: Feb. 13, 2020

(54) LENS MODULE

(71) Applicant: AAC Technologies Pte. Ltd., Singapore City (SG)

(72) Inventor: Chuandong Wei, Shenzhen (CN)

(21) Appl. No.: 16/528,667

(22) Filed: Aug. 1, 2019

(30) Foreign Application Priority Data
Aug. 7, 2018 (CN) 201821267652.1

(51) Int. Cl. G02B 13/00; H04N 5/225

(52) U.S. Cl. CPC G02B 13/0015; H04N 5/2254

(57) ABSTRACT

The present disclosure relates to the field of optical lenses, and provides a lens module. The lens module includes a lens barrel, a first lens arranged at an object side of the lens barrel, and a fixing part for pressing the first lens against the lens barrel from an object side of the first lens. The fixing part includes a top wall for pressing the first lens, and a side wall extending from an outer rim of the top wall towards an image side and fixedly connected to the lens barrel. The first lens abuts against the top wall and is spaced apart from the side wall. The lens module provided by the present disclosure has a relatively higher stability.

### TECHNICAL FIELD

The present disclosure relates to the technical field of optical lenses, and in particular, to a lens module.

### BACKGROUND

With development of technologies, various devices are equipped with a lens module. For example, with respect to safety hazard during driving a vehicle, the vehicle is equipped with a vehicle-mounted lens module. In the related art, the vehicle-mounted lens usually includes a lens barrel and a plurality of lenses received in the lens barrel. The plurality of lenses is mounted into the lens barrel from an image side, and adjacent lenses match each other and are fixed in the lens barrel.

The inventors have found the following problem in the prior art: the lenses are subjected to external forces caused by, for example, vibration, friction, and collision during use of the vehicle-mounted lens module. Since the lenses of the vehicle-mounted lens module in the related art are fixed to each other through mutual matching, the lenses will be easily loosened during use. As a result, the lens module has poor stability and cannot be adapted to a bad operating environment. Therefore, it is urgent to provide a new lens module to solve the above problem.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic cross-sectional view of a lens module according to an embodiment of the present disclosure;

FIG. 2 is an enlarged view of a portion A of FIG. 1;

FIG. 3 is a structural schematic cross-sectional view of a lens module according to another embodiment of the present disclosure; and

FIG. 4 is an enlarged view of a portion B of FIG. 3.

### DESCRIPTION OF EMBODIMENTS

The present disclosure will be further illustrated with reference to the accompanying drawings and the embodiments.

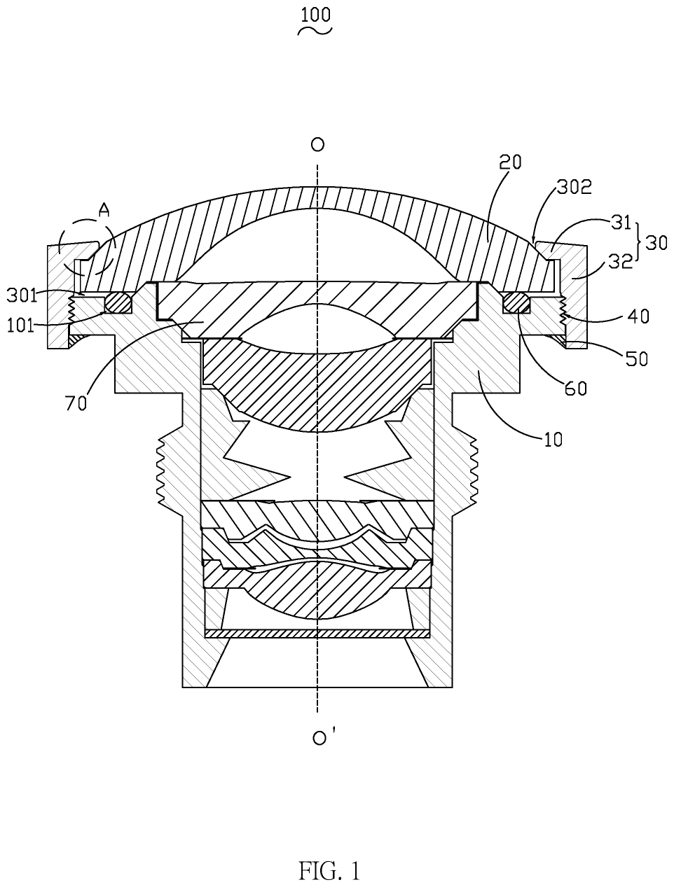

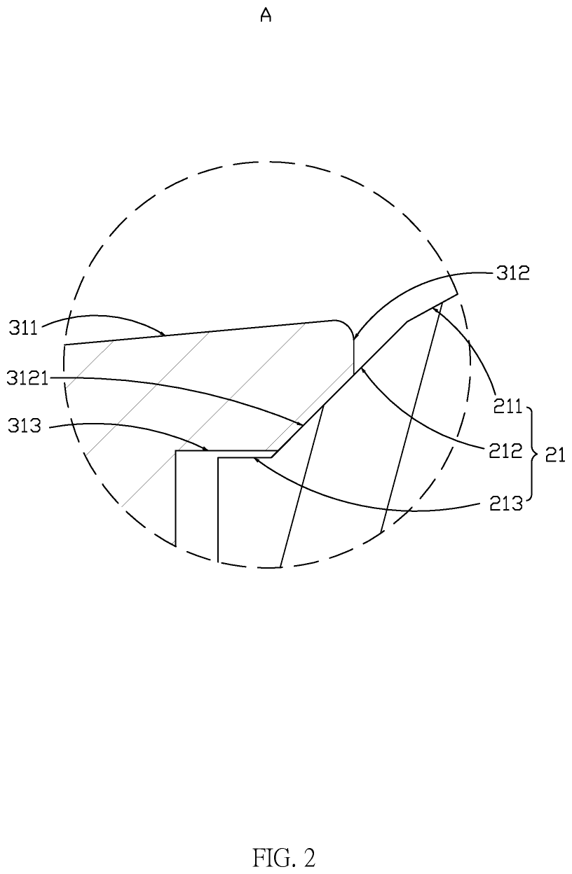

An embodiment of the present disclosure provides a lens module 100. As shown in FIG. 1 and FIG. 2, the lens module 100 includes a lens barrel 10, a first lens 20 arranged at an object side of the lens barrel 10, and a fixing part 30 for pressing the first lens 20 against the lens barrel 10 from an object side of the first lens 20. The fixing part 30 includes a top wall 31 configured to press the first lens 20, and a side wall 32 extending from an outer rim of the top wall 31 towards the image side and fixedly connected to the lens barrel 10. The first lens 20 abuts against the top wall 31 and is spaced apart from the side wall 32.

Compared with the related art, in this embodiment of the present disclosure, the fixing part 30 presses the first lens 20 against the lens barrel 10 to fix the first lens 20 to the lens barrel 10, the top wall 31 of the fixing part 30 presses the first lens 20 from the object side, and the side wall 32 is connected to the lens barrel 10, thereby locking the first lens 20. In this way, the looseness of the first lens 20 during use can be avoided, thereby improving the stability and reliability of the lens module 100. Moreover, the first lens 20 is spaced apart from the side wall 32 of the fixing part 30, and thus the friction between the first lens 20 and the side wall 32 during assembling, which may cause damaging of the first lens 20, can be avoided. Since the first lens 20 is arranged at the object side of the lens barrel 10 and is independent of the assembling of other optical elements disposed in the lens barrel 10, the first lens 20 closest to the object side can be replaced without taking out all optical elements in the lens barrel 10 when the first lens 20 is abraded. Therefore, the operation thereof is simple and convenient.

In an embodiment, the first lens 20 includes an incident surface 21 close to the object side. The incident surface 21 includes an incident portion 211 located at a central position, a matching portion 212 surrounding the incident portion 211, and a supporting portion 213 surrounding the matching portion 212.

The fixing part 30 includes a top wall 31 and a side wall 32. The top wall 31 and the side wall 32 define a receiving space 301, in which an end of the lens barrel 10 close to the object side is received.

The top wall 31 includes an object side surface 311, an image side surface 313 disposed opposite to object side surface 311, and a connecting surface 312 connecting the object side surface 311 with the image side surface 313. The connecting surface 312 includes an oblique surface 3121 connected to the image side surface 313 and is oblique with respect to an optical axis OO′ of the lens module 100. The oblique surface 3121 encloses a light through hole 302.

Preferably, the oblique surface 3121 is attached to the matching portion 212 of the first lens 20, and the image side surface 313 directly faces the supporting portion 213. The oblique surface 3121 matches the matching portion 212. The first lens 20 slides into the fixing part 30 during the assembling, until the matching portion 212 of the first lens 20 is attached to the oblique surface 3121 of the fixing part 30. In this way, it is unnecessary to adjust a relative position between the first lens 20 and the fixing part 30, thereby simplifying the assembling process and guaranteeing an accurate positioning and a stable fixation between the first lens 20 and the fixing part 30. Moreover, as the matching portion 212 surrounding the incident portion 211 is attached to the oblique surface 3121 enclosing the light through hole 302, the first lens 20 and the fixing part 30 cannot relatively move in a direction perpendicular to the optical axis OO′. In this way, it can be ensured that the first lens 20 and the light through hole 302 have a high concentricity. In this embodiment, the image side surface 313 of the top wall 31 is spaced apart from the supporting portion 213 to ensure a tight contact between the oblique surface 3121 and the matching portion 212 and a firm fixation between the fixing part 30 and the first lens 20. In practical applications, the image side surface 313 may also be in contact with the supporting portion 213. In an embodiment, the image side surface 313 is parallel to the supporting portion 213, thereby preventing the image side surface 313 from abutting against the supporting portion 213 during assembling and prevent the first lens 20 from being scratched.

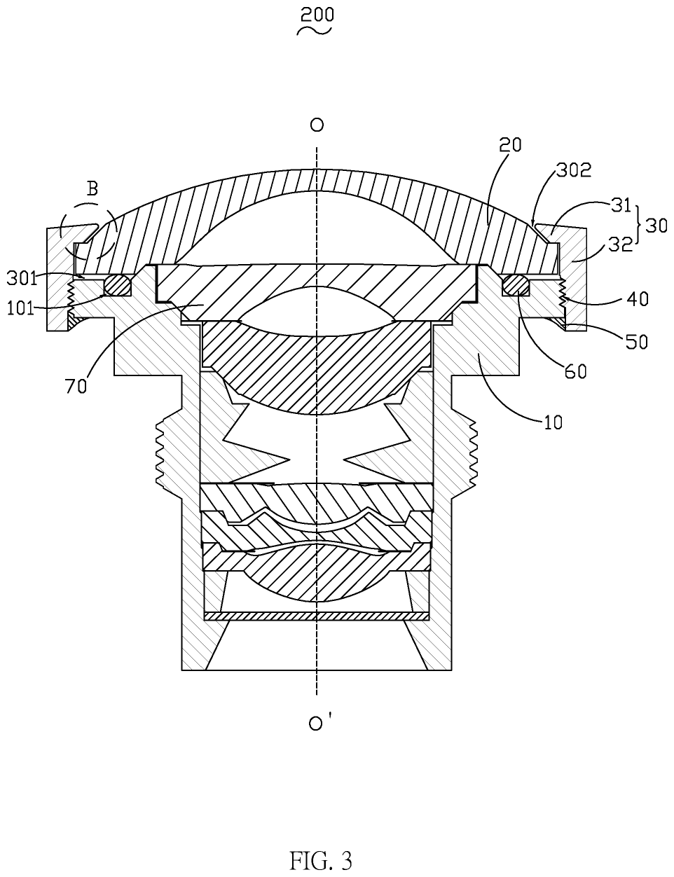

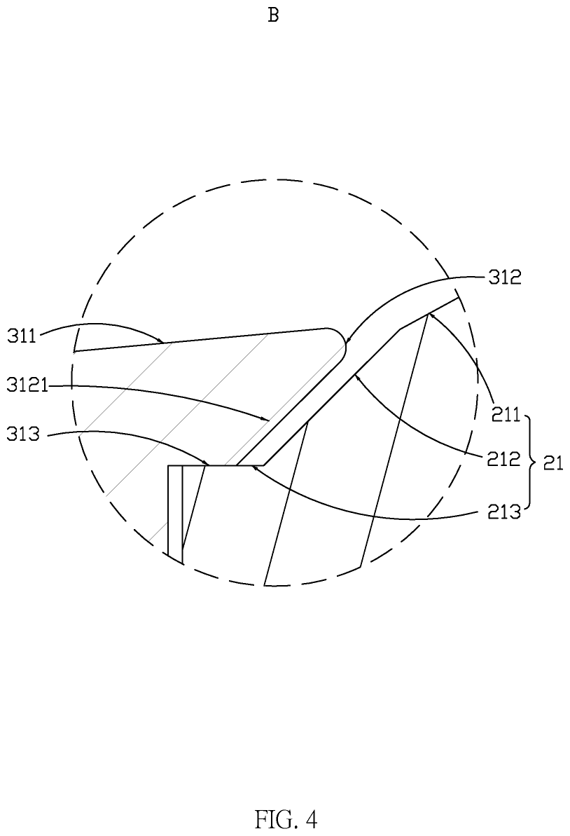

It should be noted that, a matching manner of the top wall 31 and the first lens 20 is not limited to that the matching portion 212 of the first lens 21 is attached to the oblique surface 3121 of the fixing part 30. According to various application situations and requirements, different matching manners of the top wall 31 and the first lens 20 can be designed. For example, as shown in FIG. 3 and FIG. 4, the supporting portion 213 of the first lens 21 is attached to the image side surface 313 of the fixing part 30. Specifically, the oblique surface 3121 directly faces the matching portion 212 of the first lens 20, and the image side surface 313 is attached to the supporting portion 213. By pressing and fixing the first lens 20 with the image side surface 313 of the top wall 31, the image side surface 313 is attached to the supporting portion 213 in an assembled state. In this case, it is unnecessary that a size of the surface of the oblique surface 3121 must match a size of the matching portion 212. The fixing parts 30 having a same size can be used to fix the first lens 20 having different incident portions 211, thereby simplifying the assembling operation. Preferably, the oblique surface 3121 is spaced apart from the matching portion 212, so that the friction between the matching portion 212 and the oblique surface 3121 during the assembling, which may cause damaging of the first lens 20, can be avoided. More preferably, the oblique surface 3121 is parallel to the matching portion 212, thereby preventing the first lens 20 from being scratched during the assembling.

Preferably, the lens module 100 is provided with threads 40, and the side wall 32 is fixedly connected to the lens barrel 10 by means of the threads 40. In this embodiment, the fixing part 30 is a screw cap. During the assembling, the fixing part 30 is arranged at the object side of the lens barrel 10, and an end of the lens barrel 10 close to the object side is screwed into the fixing part 30, so that the fixing part 30 is tightly connected to the lens barrel 10. In this way, it can prevent the first lens 20 pressed and held between the lens barrel 10 and the fixing part 30 from departing from the lens barrel 10, and also avoid a relative displacement between the fixing part 30 and the lens barrel 10 in the direction perpendicular to the optical axis OO′, thereby avoiding an offset of a center of the light through hole 302 defined by the fixing part 30 from an optical center of the lens barrel. Therefore, the first lens 20 abutting against and fixed to the fixing part 30 and the optical elements mounted in the lens barrel 10 have a high concentricity, and the reliability of the lens module 100 is further improved.

More preferably, the side wall 32 is fixedly connected to the lens barrel 10 by means of a thermosetting glue 50. The thermosetting glue 50 is provided at a joint between the lens barrel 10 and the fixing part 30, so as to lower a possibility of the failure of the threads 40, thereby further improving the stability and reliability of the lens module 100. Meanwhile, it can also prevent external debris from entering the lens module 100 through joint between the lens barrel 10 and the fixing part 30, thereby optimizing a sealing performance of the lens module 100.

In this embodiment, the lens module 100 further includes a seal ring 60 arranged between the lens barrel 10 and the first lens 20, in order to ensure a tight connection between the first lens 20 and the lens barrel 10. More preferably, the lens barrel 10 is provided with a groove 101, and the seal ring 60 is received in the groove 101. In this way, an effective space in the lens module 100 that is occupied by the seal ring 60 can be reduced, thereby facilitating miniaturization of the lens module 100.

It should be understood by those skilled in the art that the lens module 100 can further include at least one second lens 70 received in the lens barrel 10 and located at the image side of the first lens 20. Preferably, the second lens 70 is mounted into the lens barrel 10 from the object side, and the first lens 20 is fitted in the lens barrel 10 from the object side and abuts against the second lens 70. The fixing part 30 tightly locks the optical elements such as the first lens 20 and the second lens 70 within the lens barrel 10, preventing the relative displacement between optical elements in the lens barrel 10, and thus further improving the stability and reliability of the lens module 100.

It should be understood by those skilled in the art that the above embodiments are merely some specific embodiments of the present disclosure, and various changes in form and details may be made without departing from the scope of the present disclosure.

What is claimed is:

1. A lens module, comprising:
a lens barrel;
a first lens arranged at an object side of the lens barrel; and
a fixing part for pressing the first lens against the lens barrel from an object side of the first lens,
wherein the fixing part comprises:
a top wall for pressing the first lens; and
a side wall extending from an outer rim of the top wall towards an image side and fixedly connected to the lens barrel,
wherein the first lens abuts against the top wall and is spaced apart from the side wall.

2. The lens module according to claim 1, wherein the top wall comprises an object side surface, an image side surface opposite to the object side surface, and a connecting surface connecting the object side surface with the image side surface,
the connecting surface comprises an oblique surface, the oblique surface being connected to the image side surface and oblique with respect to an optical axis of the lens module,
the first lens comprises an incident surface close to an object side, the incident surface comprising an incident portion located at a central position, a matching portion surrounding the incident portion and attached to the oblique surface, and a supporting portion surrounding the matching portion and directly facing the image side surface.

3. The lens module according to claim 2, wherein the supporting portion is spaced apart from the image side surface.

4. The lens module according to claim 3, wherein the image side surface is parallel to the supporting portion.

5. The lens module according to claim 1, wherein the top wall comprises an object side surface, an image side surface opposite to the object side surface, and a connecting surface connecting the object side surface with the image side surface,
the connecting surface comprises an oblique surface, the oblique surface being connected to the image side surface and oblique with respect to an optical axis of the lens module,
the first lens comprises an incident surface close to an object side, the incident surface comprising an incident portion located at a central position, a matching portion surrounding the incident portion and directly facing the oblique surface, and a supporting portion surrounding the matching portion and attached to the image side surface.

6. The lens module according to claim 5, wherein the matching portion is spaced apart from the oblique surface.

7. The lens module according to claim 6, wherein the matching portion is parallel to the oblique surface.

8. The lens module according to claim 2, wherein the side wall is fixedly connected to the lens barrel by means of threads.

9. The lens module according to claim 5, wherein the side wall is fixedly connected to the lens barrel by means of threads.

10. The lens module according to claim 8, wherein the side wall is fixedly connected to the lens barrel by means of a thermosetting glue.

11. The lens module according to claim 2, wherein a seal ring is provided between the lens barrel and the first lens, the lens barrel is provided with a groove, and the seal ring is received in the groove.

12. The lens module according to claim 5, wherein a seal ring is provided between the lens barrel and the first lens, the lens barrel is provided with a groove, and the seal ring is received in the groove.
